(19) United States
(12) Patent Application Publication
(10) Pub. No.: US 2013/0207675 A1
(43) Pub. Date: Aug. 15, 2013

(54) METHOD FOR OPERATING A CAPACITIVE POSITION SENSOR AND CAPACITIVE POSITION SENSOR

(71) Applicant: SICK STEGMANN GMBH, (US)

(72) Inventor: Massimo FRANCESCON, Torino (IT)

(73) Assignee: SICK STEGMANN GMBH, Donaueschingen (DE)

(21) Appl. No.: 13/755,962

(22) Filed: Jan. 31, 2013

(30) Foreign Application Priority Data
Feb. 14, 2012 (EP) 12 155 456.2

(51) Int. Cl. G01B 7/30; G01B 7/02

(52) U.S. Cl. CPC G01B 7/30; G01B 7/02
USPC 324/683

(57) ABSTRACT

A method for operating a capacitive position sensor includes providing excitation signals driving each conductive element. The excitation signals are periodic in 2π, with each set of conductive elements being provided with n different excitation signals. The different excitation signals differ in phase, wherein in a functionality check mode, the excitation signal that in a measurement mode is applied to one of the conductive elements in the functionality check mode is applied to a different one of the conductive elements. The different conductive element is the k-th conductive element counted from the one of the conductive elements, with k being an integer of 1 to n−1 and this shift of excitation signals is applied to all conductive elements. The capacitive position sensor includes a stator having a transmitter with N sets of conductive elements, each set having n conductive elements formed in a linear or circular arrangement thereon.

In numerous technical applications, it is important to obtain information on the phase of a moving, for example rotating system at a given point of time, more specifically its linear or angular position at said point of time. To obtain this information, one or more sensors are provided that generate data that are indicative of said position and the data generated by the sensors are evaluated in order to obtain the desired position information. The combination of sensors and hardware for the evaluation represents a device for controlling a moving, specifically a rotating system. Specifically, linear or rotary position encoders belong to this class of devices.

There are well known capacitive position sensors comprising a stator and a rotor, the stator comprising a transmitter and a receiver, the transmitter comprising N sets of conductive elements, each set comprising n conductive elements, the conductive elements of the transmitter formed in a linear or circular arrangement thereon, the receiver comprising a conductive plate formed thereon, the rotor comprising a linear or circumferential modulated geometry, the stator and the rotor being arranged parallel to each other and being rotatable independently, and further comprising a signal generator providing excitation signals driving each conductive elements of the plurality of conductive elements, the excitation signals being periodic in 2π and each set of conductive elements being provided with n different excitation signals, the different excitation signals differing in phase. Usually, the periodic excitation signals are rectangular signals. The capacitive position sensor provides as a result signals that can be written as a sine function and a cosine function, these functions corresponding to a specific position, for a capacitive rotary position sensor corresponding to a specific angle.

Great part of the fault detection capability is demanded to the so called vector length check, where the sine and cosine outputs are checked for consistency through the relation sin²+cos²=1. A problem of the approach described above is, that a stuck on one output to a certain level has one or two shaft positions where it is not directly detected as the level of the faulty output may be acceptable in these cases. A further problem of the approach described above is, that the fault detection feature becomes poor if the range of accepted vector length must be enlarged, which happens in capacitive encoders because of the axial displacement dependence of the signal strength.

This problem is solved by a method for checking the functionality of a capacitive position sensor with the features of claim 1 and a capacitive position sensor with the features of claim 8.

Advantageous embodiments of the method and the device are obtained by the features of the dependent claims.

A desirable functionality check would be to change the position of the capacitive position encoder, especially in case of a capacitive rotary position encoder to rotate the shaft of the capacitive rotary position encoder. Of course, this kind of check is not practicable because the actual position of the encoder should not be changed for test purposes. Therefore, the basic idea of the invention is not to move the shaft but to move the excitation signal channel assignments to simulate a movement of the capacitive position encoder.

The method according to the invention for operating a capacitive position sensor, the capacitive position sensor comprising a stator and a rotor, the stator comprising a transmitter and a receiver, the transmitter comprising N sets of conductive elements, each set comprising n conductive elements, the conductive elements of the transmitter formed in a linear or circular arrangement thereon, the receiver comprising a conductive plate formed thereon, the rotor comprising a linear or circumferential modulated geometry, the stator and the rotor being arranged parallel to each other and being rotatable independently, comprises the step of providing each conductive element with an excitation signal, the excitation signals being periodic in 2π, each set of conductive elements being provided with n different excitation signals, the different excitation signals differing in phase, wherein in a functionality check mode the excitation signal that in the measurement mode is applied to one of the conductive elements in the functionality check mode is applied to a different one of the conductive elements, the different conductive element being the k-th conductive element counted from the one of the conductive elements, k being an integer of 1 to n−1 and this shift of excitation signals being applied to all conductive elements. During the functionality check mode, the excitation signal channel assignments temporarily are changed, which leads to a simulation of a movement of the capacitive position sensor, especially rotation of the shaft of the capacitive rotary position sensor. Therefore, an effective functionality test can be provided.

According to a preferred embodiment of the invention, each of the conductive elements is divided in x conductive part elements, wherein in the measurement mode the x conductive part elements of each conductive element are driven with an identical excitation signal and wherein in the functionality check mode the excitation signal that in the measurement mode is applied to one of the conductive part elements in the functionality check mode is applied to a different one of the conductive part elements, the different conductive part element being the w-th conductive part element counted from the one of the conductive part elements, w being an integer of 1 to x*n−1 and this shift of excitation signals being applied to all conductive part elements.

Preferably, the functionality check mode comprises at least two evaluation modes, the evaluation modes differ in the value of k or w. Thus a more effective functionality test can be provided.

Preferably, a number of n excitation signals with phases φₙ is used, wherein φⱼ=j*2π/n, j being an integer of 0 to n−1.

In a preferred embodiment of the invention, n is equal to 4. Therefore, the phase shift between the excitation signals is π/2 which corresponds to 90°, which allows simplifying calculations enormously.

Preferably, N is equal to 16 to provide sufficient resolution.

According to a preferred embodiment, x is equal to 2 to allow simplifying calculations.

In an embodiment, the functionality check mode is performed each time the capacitive position sensor is turned on to provide especially automatically information whether the capacitive position sensor is working correctly.

The capacitive position sensor according to the invention comprises at least one stator and one rotor, the stator comprising a transmitter and a receiver, the transmitter comprising N sets of conductive elements, each set comprising n conductive elements, the conductive elements of the transmitter formed in a linear or circular arrangement thereon, the receiver comprising a conductive plate formed thereon, the rotor comprising a linear or circumferential modulated geometry, the stator and the rotor being arranged parallel to each other and being rotatable independently, and further comprises a signal generator providing excitation signals driving each conductive element of the plurality of conductive elements, the excitation signals being periodic in 2π, each set of conductive elements being provided with n different excitation signals, the different excitation signals differing in phase, wherein a functionality check mode the excitation signal that in a measurement mode is applied to one of the conductive elements in the functionality check mode is applied to a different one of the conductive elements, the different conductive element being the k-th conductive element counted from the one of the conductive elements, k being an integer of 1 to n−1 and this shift of excitation signals being applied to all conductive elements.

Preferably, each of the conductive elements is divided in x conductive part elements, wherein in the measurement mode the x conductive part elements of each conductive element are driven with an identical excitation signal and wherein in the functionality check mode the excitation signal that in the measurement mode is applied to one of the conductive part elements in the functionality check mode is applied to a different one of the conductive part elements, the different conductive part element being the w-th conductive part element counted from the one of the conductive part elements, w being an integer of 1 to x*n−1 and this shift of excitation signals being applied to all conductive part elements. Introducing conductive part elements leads to a more effective check of the functionality of the capacitive position sensor, because special faults might not be detected by moving the excitation signals from one conductive element to the next conductive element.

Preferably, the circumferential modulated geometry of the rotor comprises N elements, the angular width of one of the N elements corresponding to the angular width of one set of conductive elements.

According to a preferred embodiment of the invention, the stator comprises a stator plate, the stator plate having formed thereon both the transmitter and the receiver, and in that the rotor os made of a reflective material. In this case, a quite compact two-plate arrangement can be achieved.

According to an alternative preferred embodiment of the invention, the stator comprises a first stator plate, being arranged on a first side of the rotor and comprising the transmitter, and a second stator plate, being arranged on a second side of the rotor, opposite the first side, and comprising the receiver and in that the rotor is made of a dielectric material. In this case, a three-plate arrangement can be achieved having a constant area of the electrodes that is used for evaluation.

Preferably, the capacitive position sensor is a capacitive rotary position sensor.

Next, the invention is explained in more detail using figures of an embodiment of the invention and a figure illustrating the state of the art. In the figures show

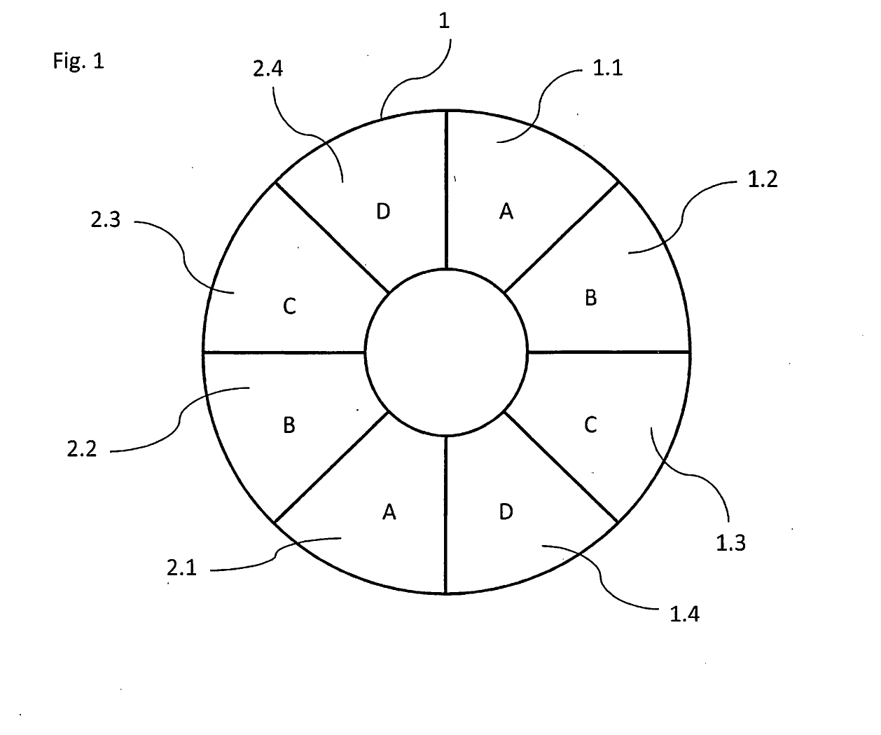

FIG. 1 a schematic view of a transmitter of a capacitive rotary position sensor including the arrangement of excitation signals in a measuring mode,

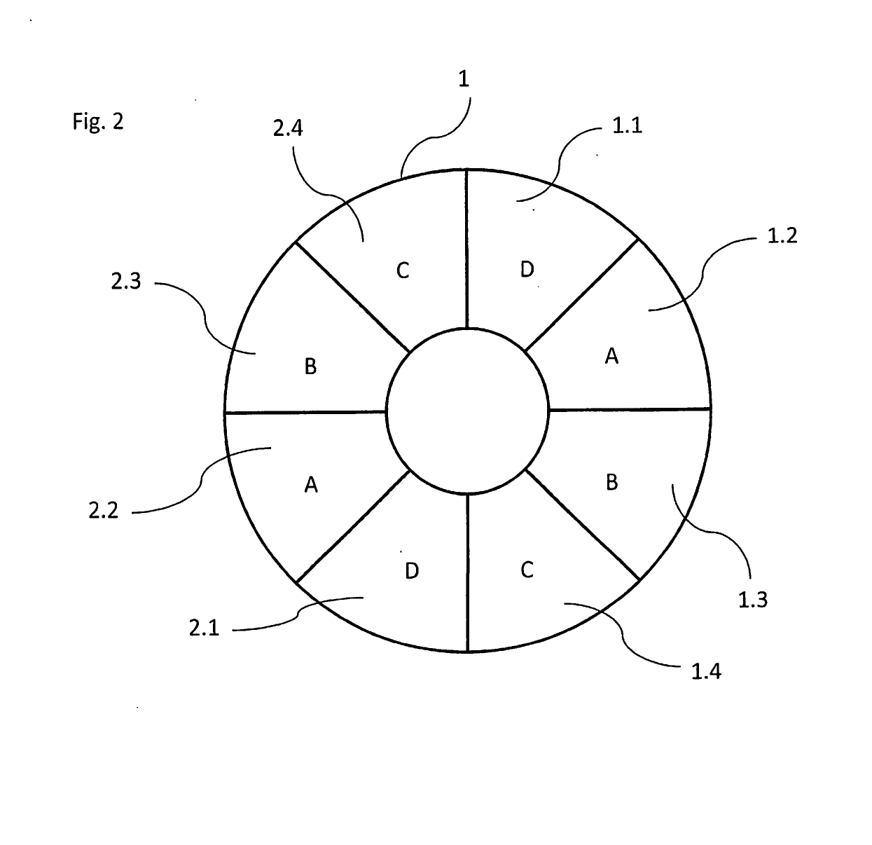

FIG. 2 a schematic view of the transmitter of a capacitive rotary position sensor according to FIG. 1 including the arrangement of excitation signals in a functionality check mode,

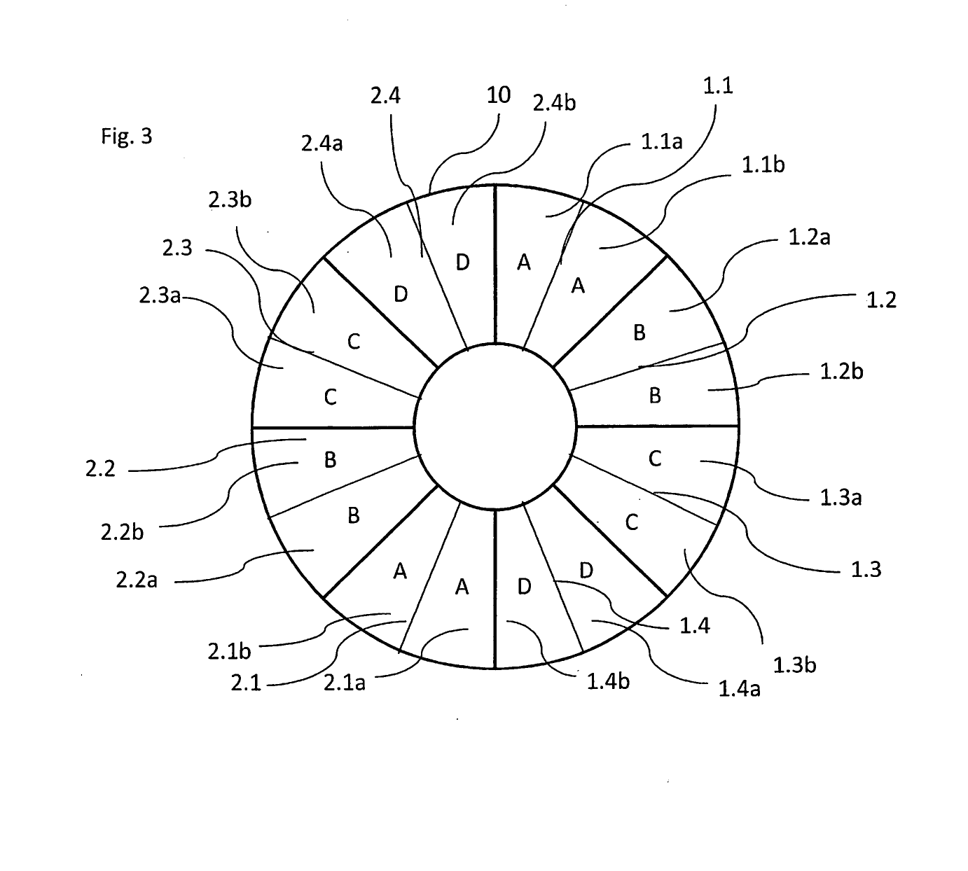

FIG. 3 a schematic view of a transmitter of a capacitive rotary position sensor comprising conductive part elements including the arrangement of excitation signals in a measuring mode,

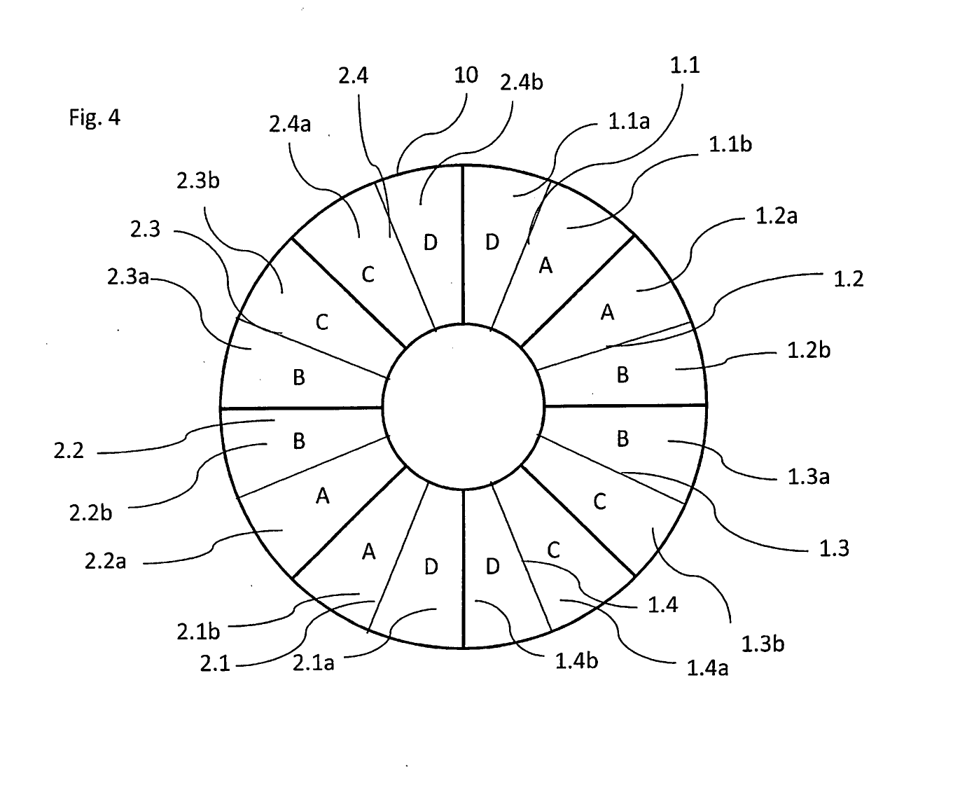

FIG. 4 a schematic view of a transmitter of a capacitive rotary position sensor according to FIG. 3 including the arrangement of excitation signals in a functionality check mode, and

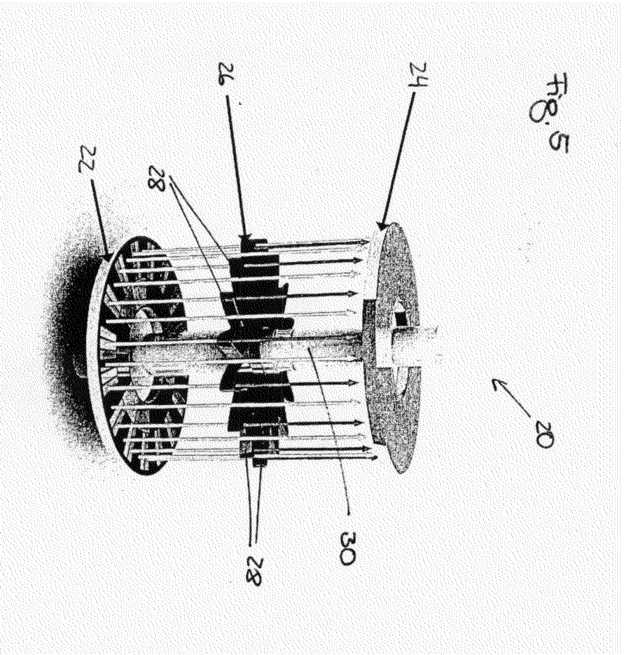

FIG. 5 a schematic view of a capacitive rotary position sensor comprising a transmitter, a receiver and a dielectric element.

FIG. 1 shows a schematic view of a transmitter 1 of a capacitive rotary position sensor including the arrangement of excitation signals. The transmitter comprises a number of N sets of conductive elements 1.1, 1.2, 1.3, 1.4, 2.1, 2.2, 2.3, 2.4, wherein N is equal to 2 for a simplified graphical presentation. Preferably, N is a larger integral number, for example N is equal to 16. Each set of conductive elements comprises n conductive elements, wherein n is equal to 4. Therefore, in the present embodiment, the first set comprises conductive elements 1.1, 1.2, 1.3, 1.4 and the second set comprises conductive elements 2.1, 2.2, 2.3, 2.4. All conductive elements 1.1, 1.2, 1.3, 1.4, 2.1, 2.2, 2.3, 2.4 are arranged in a circular arrangement on the transmitter 1, especially in a symmetrical manner.

Each conductive element 1.1, 1.2, 1.3, 1.4, 2.1, 2.2, 2.3, 2.4 is driven with an excitation signal. The excitation signals are periodic in 2π. The excitations signals are preferably rectangular signals. Each set of conductive elements is provided with n different excitation signals, the different excitation signals differing in phase. Excitation signals of adjacent conductive elements have in the present embodiment a phase shift of 2π/n, in the present case a phase shift of π/2 which corresponds to 90°. In the embodiment of FIG. 1, four different excitations signals A, B, C, D are used. Excitation signal A has a phase of 0°, excitation signal B has a phase 90°, excitation signal C has a phase of 180° and excitation signal D has a phase of 270°. For each set of conductive elements, for example for the conductive elements 1.1, 1.2, 1.3, 1.4, four different excitation signals A, B, C, D are used. Therefore, each conductive element 1.1, 1.2, 1.3, 1.4 of a single set of conductive elements is driven with a different excitation signal. For example, in a measurement mode the conductive elements 1.1 and 2.1 are driven with excitation signal A, the conductive elements 1.2 and 2.2 are driven with excitation signal B, the conductive elements 1.3 and 2.3 are driven with excitation signal C, and the conductive elements 1.4 and 2.4 are driven with excitation signal D.

In a functionality check mode, which is shown in FIG. 2, the excitation signal that in the measurement mode is applied to one of the conductive elements in the functionality check mode is applied to a different one of the conductive elements, the different conductive element being the k-th conductive element counted from the one of the conductive elements, k being an integer of 1 to n−1 and this shift of excitation signals being applied to all conductive elements. FIG. 2 shows the functionality check mode for k being equal to 1. In this case, in the functionality check mode the conductive elements 1.1 and 2.1 are driven with excitation signal D, the conductive elements 1.2 and 2.2 are driven with excitation signal A, the conductive elements 1.3 and 2.3 are driven with excitation signal B, and the conductive elements 1.4 and 2.4 are driven with excitation signal C. For a more effective test, a further functionality check mode can be performed using k equal to 2 and/or k equal to 3.

FIGS. 3 and 4 show an second embodiment of a transmitter 10 according to the invention, in which each conductive element 1.1, 1.2, 1.3, 1.4, 2.1, 2.2, 2.3, 2.4 is divided in x conductive part elements 1.1a, 1.1b, 1.2a, 1.2b, 1.3a, 1.3b, 1.4a, 1.4b, 2.1a, 2.1b, 2.2a, 2.2b, 2.3a, 2.3b, 2.4a, 2.4b, x being equal to 2. Preferably, the conductive part elements 1.1a, 1.1b, 1.2a, 1.2b, 1.3a, 1.3b, 1.4a, 1.4b, 2.1a, 2.1b, 2.2a, 2.2b, 2.3a, 2.3b, 2.4a, 2.4b all are of the same size and are arranged in a circular arrangement on the transmitter 10, especially in a symmetrical manner.

FIG. 3 shows the transmitter 10 in a measurement mode, in which the conductive part elements 1.1a, 1.1b, 1.2a, 1.2b, 1.3a, 1.3b, 1.4a, 1.4b, 2.1a, 2.1b, 2.2a, 2.2b, 2.3a, 2.3b, 2.4a, 2.4b which belong to one of the conductive elements 1.1, 1.2, 1.3, 1.4, 2.1, 2.2, 2.3, 2.4 are driven with an identical excitation signal. For example, the conductive part elements 1.2a, 1.2b of the conductive element 1.2 are driven with excitation signal B.

FIG. 4 shows the transmitter 10 of FIG. 3 in a functionality check mode. In the functionality check mode, the excitation signal that in the measurement mode is applied to one of the conductive part elements in the functionality check mode is applied to a different one of the conductive part elements, the different conductive part element being the w-th conductive part element counted from the one of the conductive part elements, w being an integer of 1 to x*n−1 and this shift of excitation signals being applied to all conductive part elements. For example, in FIG. 3 w is equal to 1. For example, if in the measurement mode the conductive part element 1.1a is driven with excitation signal A, the w-th conductive part element with w being equal to 1 is the conductive part element 1.1b. Therefore, in the functionality check mode with w=1, excitation signal A would be applied to the conductive part element 1.1b. The w-th conductive part element with w being equal to 1 counted from the conductive part element 1.1b is the conductive part element 1.2a. Therefore, in the functionality check mode with w=1, excitation signal A, that was applied to conductive part element 1.1b in the measurement mode would be applied to the conductive part element 1.2a.

This arrangement can especially be achieved by moving the excitations signals on the transmitter 10 for example by one conductive part element, which is to say the excitation signal of the conductive part element 1.1a is applied to the conductive part element 1.1b, the excitation signal of the conductive part element 1.1b is applied to the conductive part element 2.1a, the excitation signal of the conductive part element 2.1a is applied to the conductive part element 2.1b and so on. Alternatively, the excitations signals on the transmitter are not only moved by one conductive part element, but by a number of w conductive part elements, w being an integer from 1 to x*n−1.

For a more effective test, the functionality check mode comprises according to a preferred embodiment at least two evaluation modes, the evaluation modes differ by the value of w. In the present example, the different evaluation modes can be achieved by moving the excitations signals on the transmitter 10 for example by two different numbers w of conductive part elements, for example by w=1 and by w=2 or w=3.

The following table gives an overview of examples of excitation signal assignments to the respective conductive part elements of the transmitter 10 shown in FIGS. 3 and 4 in the measurement mode and in different functionality check modes:

| | | Excitation | Excitation | Excitation |
|---|---|---|---|---|
| | Excitation | signal in | signal in | signal in |
| Conductive | signal in | functionality | functionality | functionality |
| part | measurement | check mode | check mode | check mode |
| element | mode | w = 1 | w = 2 | w = 3 |
| 1.1a | A | D | D | C |
| 1.1b | A | A | D | D |
| 1.2a | B | A | A | D |
| 1.2b | B | B | A | A |
| 1.3a | C | B | B | A |
| 1.3b | C | C | B | B |
| 1.4a | D | C | C | B |
| 1.4b | D | D | C | C |
| 2.1a | A | D | D | C |
| 2.1b | A | A | D | D |
| 2.2a | B | A | A | D |
| 2.2b | B | B | A | A |
| 2.3a | C | B | B | A |
| 2.3b | C | C | B | B |
| 2.4a | D | C | C | B |
| 2.4b | D | D | C | C |

Preferably, the functionality check mode is performed each time the capacitive rotary position encoder is turned on. If the results of the functionality check mode do not correspond to the expected results, an alarm might be set.

FIG. 5 shows a schematic vies of a capacitive rotary position sensor 20 according to the state of the art. The capacitive rotary position sensor 20 comprises a transmitter 22, a receiver 24 and a dielectric element 26. The transmitter 22 is adapted to generate an electrostatic field; the receiver 24 is adapted to receive the electrostatic field. The transmitter 22 comprising N sets of electrical conductive elements, each set comprising n conductive elements. According to the present embodiment n is equal to 4. The conductive elements of the transmitter 22 are arranged in a circular arrangement. In the embodiment according to FIG. 4, the transmitter 22 comprises two circular arrangements of N sets of conductive elements. An outer circular arrangement of conductive element comprises N=16 sets of conductive elements, an inner circular arrangement of conductive elements comprises N=3 sets of conductive elements. Each set of conductive elements comprises four conductive elements. Each conductive element is provided with an excitation signal provided by a signal generator, each set of conductive elements being provided with n different excitation signals, the different excitation signals differing in phase. Especially, each first conductive element of the sets of conductive elements is driven by an identical excitation signal. Likewise, each second, each third and each fourth element of the sets of conductive elements is driven by an identical excitation signal.

The receiver 24 comprises a circular electrical conductive plate formed thereon. The transmitter 22 and the receiver 24 are arranged parallel to each other, wherein the plurality of conductive elements faces the circular conductive plate.

The sensor 20 further comprises a dielectric element 26 with a circumferential modulated geometry. Especially, the dielectric element 26 comprises a circumferential modulated geometry of N elements 28, N for example being equal to 16, the angular width of one of the N elements 28 corresponding to the angular width of one set of conductive elements. The dielectric element 26 is adapted to modulate the electrostatic field between the transmitter 22 and the receiver 24.

The transmitter 22 and the receiver 24 form a stator, the stator comprising a first stator plate comprising the transmitter 22 and a second stator plate comprising the receiver 24. The dielectric element 26 forms a rotor. The stator and the rotor are arranged parallel to each other and are rotatable independently. The rotor is arranged parallel on a shaft 30. Usually, the stator is fixed in its position and the rotor is rotatable.

### REFERENCE NUMBERS

1 transmitter
10 transmitter
1.1 conductive element
1.1a conductive element
1.1a conductive element
1.2 conductive element
1.2a conductive element
1.2b conductive element
1.3 conductive element
1.3a conductive element
1.3b conductive element
1.4 conductive element
1.4a conductive element
1.4b conductive element
2.1 conductive element
2.1a conductive element
2.1b conductive element
2.2 conductive element
2.2a conductive element
2.2b conductive element
2.3 conductive element
2.3a conductive element
2.3b conductive element
2.4 conductive element
2.4a conductive element
2.4b conductive element
20 capacitive rotary position sensor
22 transmitter
24 receiver
26 dielectric element
28 element
28 shaft
A excitation signal
B excitation signal
C excitation signal
D excitation signal

1. Method for operating a capacitive position sensor, the capacitive position sensor comprising
a stator, the stator comprising a transmitter and a receiver, the transmitter comprising N sets of conductive elements, each set comprising n conductive elements, the conductive elements of the transmitter formed in a linear or circular arrangement thereon,
the receiver comprising a conductive plate formed thereon,
a rotor, the rotor comprising a linear or circumferential modulated geometry, the stator and the rotor being arranged parallel to each other and being rotatable independently, the method comprising the step of providing each conductive element with an excitation signal, the excitation signals being periodic in 2π, each set of conductive elements being provided with n different excitation signals, the different excitation signals differing in phase, characterized in that in a functionality check mode the excitation signal that in a measurement mode is applied to one of the conductive elements in the functionality check mode is applied to a different one of the conductive elements, the different conductive element being the k-th conductive element counted from the one of the conductive elements, k being an integer of 1 to n−1 and this shift of excitation signals being applied to all conductive elements.

2. Method according to claim 1,
characterized in that each of the conductive elements is divided in x conductive part elements, wherein in the measurement mode the x conductive part elements of each conductive element are driven with an identical excitation signal and wherein in the functionality check mode the excitation signal that in the measurement mode is applied to one of the conductive part elements in the functionality check mode is applied to a different one of the conductive part elements, the different conductive part element being the w-th conductive part element counted from the one of the conductive part elements, w being an integer of 1 to x*n−1 and this shift of excitation signals being applied to all conductive part elements.

3. Method according to claim 1,
characterized in that the functionality check mode comprises at least two evaluation modes, the evaluation modes differ in the value of k or w.

4. Method according to claim 1, characterized in that n is equal to 4.

5. Method according to claim 1, characterized in that N is equal to 16.

6. Method according to claim 1, characterized in that x is equal to 2.

7. Method according to claim 1, characterized in that the functionality check mode is performed each time the capacitive position sensor is turned on.

8. Capacitive position sensor comprising
at least one stator, the stator comprising a transmitter and a receiver, the transmitter comprising N sets of conductive elements, each set comprising n conductive elements, the conductive elements of the transmitter formed in a linear or circular arrangement thereon,
the receiver comprising a conductive plate formed thereon,
a rotor, the rotor comprising a linear or circumferential modulated geometry,
the stator and the rotor being arranged parallel to each other and being rotatable independently, and further comprising a signal generator providing excitation signals driving each conductive element of the plurality of conductive elements, the excitation signals being periodic in 2π, each set of conductive elements being provided with n different excitation signals, the different excitation signals differing in phase,
characterized in that in a functionality check mode the excitation signal that in a measurement mode is applied to one of the conductive elements in the functionality check mode is applied to a different one of the conductive elements,
the different conductive element being the k-th conductive element counted from the one of the conductive elements, k being an integer of 1 to n−1 and this shift of excitation signals being applied to all conductive elements.

9. Capacitive position sensor according to claim 8,
characterized in that each of the conductive elements is divided in x conductive part elements, wherein in the measurement mode the x conductive part elements of each conductive element are driven with an identical excitation signal and wherein in the functionality check mode the excitation signal that in the measurement mode is applied to one of the conductive part elements in the functionality check mode is applied to a different one of the conductive part elements, the different conductive part element being the w-th conductive part element counted from the one of the conductive part elements, w being an integer of 1 to x*n−1 and this shift of excitation signals being applied to all conductive part elements.

10. Capacitive position sensor according to claim 8,
characterized in that the circumferential modulated geometry of the rotor comprises N elements, the angular width of one of the N elements corresponding to the angular width of one set of conductive elements.

11. Capacitive position sensor according to claim 8,
characterized in that the stator comprises a stator plate, the stator plate having formed thereon both the transmitter and the receiver, and in that the rotor is made of a reflective material.

12. Capacitive position sensor according to claim 8,
characterized in that the stator comprises a first stator plate, being arranged on a first side of the rotor and comprising the transmitter, and a second stator plate, being arranged on a second side of the rotor, opposite the first side, and comprising the receiver and in that the rotor is made of a dielectric material.

13. Capacitive position sensor according to claim 8,
characterized in that the capacitive position sensor is a capacitive rotary position sensor.

14. Capacitive position sensor according to claim 8,
characterized in that n is equal to 4 and/or N is equal to 16 and/or x is equal to 2.
